(19) United States
(12) Patent Application Publication
(10) Pub. No.: US 2023/0391415 A1
(43) Pub. Date: Dec. 7, 2023

(54) Steering System for Bicycle Handlebars

(71) Applicant: Canyon Bicycles GmbH, Koblenz (DE)

(72) Inventors: Moritz Ströer, Koblenz (DE); Leo Malmeryd, Stockholm (SE); Vincenz Thoma, Obermaiselstein (DE)

(21) Appl. No.: 18/204,617

(22) Filed: Jun. 1, 2023

(30) Foreign Application Priority Data
Jun. 2, 2022 (DE) 20 2022 103 131.2

(51) Int. Cl. B62K 3/02

(52) U.S. Cl. CPC B62K 3/02

(57) ABSTRACT

A steering system for bicycle handlebars includes a steer tube pivotably supported in a head tube of a bicycle frame via two bearing elements. A first stop element is connected to the steer tube to limit the steering lock. A second stop element is connected to the bicycle frame, in particular the head tube. The first stop element is arranged inside the head tube between the two bearing elements.

### CROSS-REFERENCE TO RELATED APPLICATION

This application claims priority to German Patent Application No. 20 2022 103 131.2 filed Jun. 2, 2022, the disclosure of which is hereby incorporated by reference in its entirety.

### BACKGROUND OF THE INVENTION

### Field of the Invention

The invention relates to a steering system for bicycle handlebars.

### Description of Related Art

For example in the event of a fall or if a bicycle falls over, there is a risk of the top tube being damaged, in particular by components mounted to the handlebar, such as brake and/or shift handles. Such damage must be avoided, in particular with bicycle frames made of fiber-reinforced plastics, such as carbon, since this may possibly even cause a destruction of the bicycle frame.

From DE 20 2012 008 119.5 a steering stop is known which comprises a first stop element adapted to be clamped to the steer tube of a bicycle fork. A second stop element, which serves to limit a steering lock, cooperates with the first stop element. The second stop element is attached to an upper side of the top tube by two screws. Such a steering stop may be suitable for mountain bikes and trekking bicycles, but has the disadvantage that such external steering systems are susceptible to dirt.

### SUMMARY OF THE INVENTION

It is an object of the invention to provide a steering system for bicycle handlebars that is in particular protected from being soiled.

The object is achieved, according to the invention, with a steering system having the features as described herein.

The steering system for bicycles according to the invention comprises a steer tube of a front wheel fork, which is in particular connected to two fork legs via a fork bridge. At the upper end of the mounted steer tube, a handlebar can be connected to the steer tube via a handlebar stem. The steer tube is rotatably supported at a head tube of the bicycle frame. For this purpose, two bearing elements are provided in the head tube which are in particular ball bearings. The steering system for bicycle handlebars according to the invention comprises a first stop element which can be fixed to the steer tube. This first stop element has two stops. A left and a right steering lock are limited by means of these two stops. Further, a second stop element is provided that can be fixed to the bicycle frame and cooperates with the first stop element. According to the invention, the first stop element is arranged on the steer tube between the two bearing elements. The first stop element is thus arranged inside the head tube and, as such, is protected against dirt by the head tube. Such an arrangement of the first stop element further has the advantage that it is an integrated element which is not or only slightly visible from outside. Due to the arrangement of the first stop element between the two bearing elements it is possible, in a particularly preferred embodiment, to arrange and mount the same independent of the bearing elements. It is thus not necessary to provide specially designed bearing elements. Further, mounting the bearing elements is not made more difficult.

The first stop element is preferably fixed to the steer tube in a force-locked manner, in particular in a clamped manner. This is a low-cost design of the first stop element which can, in addition, be mounted in a simple manner. A form-fitting connection between the first stop element and the steer tube would also be possible, for example in the form of a serration, a fluting, corresponding protrusions and recesses or the like. A force-locking connection could be made by pressing, where it is preferred to clampingly fix the first stop element on the steer tube.

Preferably, the first stop element is designed to be annular in shape and preferably surrounds the steer tube completely. It is particularly preferred that the in particular annular first stop element can be fixed to the steer tube by means of a clamping element. In a particularly preferred embodiment this is realized by the first stop element being annular in shape and having a slot. Using a clamping element, in particular in the form of a screw, a clamped fixing of the first stop element to the steer tube can be realized in a simple manner.

The steer tube preferably comprises a cylindrical portion between the two bearing elements, in which the first stop element is arranged. Due to the arrangement of the first stop element in a cylindrical portion, a clamping fixation can be realized in particular in a simple manner. It is preferred that this cylindrical portion is designed such that also the upper bearing element is arranged in the same cylindrical portion. It is also possible to provide two cylindrical portions having different diameters, while one cylindrical portion having a uniform diameter is preferred in particular for manufacturing reasons.

In a preferred embodiment, the cylindrical portion is adjoined by a conical portion that widens towards the lower bearing element. The diameter of the steer tube thus increases towards the lower bearing element, starting from the cylindrical portion. The lower bearing element itself is preferably arranged in a cylindrical portion having a larger diameter.

It is particularly preferred that the two stops of the first stop element comprise stop surfaces. In the event of an extreme right or left steering lock of the handlebar, these surfaces come into contact with the second stop element at the respective limit angles. The two stop surfaces preferably have an angle of at least 180° with respect to each other. Specifically, the angle is >220°, with the angle preferably being <300°, in particular <240°. Thus, the handlebar can be turned by at least 90°, in particular less than 120°, with respect to the traveling direction, before the left or right stop surface comes to contact second stop element.

Preferably, in particular the head tube has a recess in which the second stop element is arranged. In particular, the second stop element can be inserted into this recess. The fixing can be effected using corresponding fixing means, locking elements or also in a clamping manner, in particular solely due to form fit. The recess in which the second stop element is arranged is preferably open to the traveling direction of the bicycle, i.e. at a front side of the head tube. It is particularly preferred that the second stop element comprises a retaining element which serves for connection to the bicycle frame, in particular for insertion into the recess.

The second stop element may, for example, also be of a two-part design. Here, the part of the second stop element comprising the two stops may be provided on an inner side of the head tube, and a holding or fixing element may be provided on an outer side of the head tube. Both parts can then be connected to each other through a recess in the head tube. The connection can be made, for example, using screw, a locking connection or the like. In this manner, a simple assembly and at the same time a good force transmission are possible.

In an alternative embodiment of the second stop element, the same may be designed as an integral part of the head tube. For this purpose, the stop element is, for example, provided on the inner side of the head tube already during the manufacture of the head tube or is even formed integrally with the same. For the arrangement of an integrated second stop element on the inner side of the head tube, a small opening or recess may be provided in the inner side of the head tube, into which a protrusion or pin of the second stop element is inserted from inside. The second stop element is then fixed on the inner side of the head tube, for example by gluing. The recess in the inner side of the head tube, into which a protrusion of the second stop element protrudes, serves for force transmission. The recess in the inner side of the head tube may be designed such that it is not going through, so that the outer side of the head tube remains closed. A through-going opening may also be provided for receiving the pin or the protrusion. After the fixation, in particular the gluing, of the second stop element, the hole can be filled and ground from outside, so that after painting the head tube the second stop element is not visible afterwards.

Preferably, a recess or an opening is provided in the head tube provide access to the clamping element, in particular with a tool.

In particular, the arrangement of the first stop element between the two bearing elements has the advantage that the two stops of the stop element can have a relatively large stop surface, so that the possibly great forces occurring can be transmitted uniformly. This is a significant advantage in particular over steering stops visibly arranged above the upper bearing element, since these have to be arranged in a small installation space and thus necessarily have small stop surfaces.

In a particularly preferred development of the invention, the first stop element is connected to a steering stabilization. The steering stabilization serves in particular to stabilize straight-ahead traveling. It is preferred to provide a spring element as the steering stabilization, so that the steering stabilization comprises at least one spring element. The spring element, which may be an elastic element, a stretchable band, a spring or the like, generates a restoring force. This restoring force is generated by a steering movement, so that a restoring moment is generated. It is preferred that the steering stabilization means is arranged at least in part in the top tube of the bicycle frame. It is particularly preferred that the steering stabilization means is not visible from outside and, as such, is arranged entirely inside the top tube and the head tube of the frame. For example, two stabilization elements of band-shaped design can be arranged opposite each other, i.e., in particular laterally, at the first stop element. The two band-shaped stabilization elements are guided towards the top tube and are themselves elastic and/or connected to an elastic element. The steering stabilization means may also be designed as a torsion spring or comprise a torsion spring.

### BRIEF DESCRIPTION OF THE DRAWINGS

In the following, the Figures are explained in more detail by means of preferred embodiments with reference to the accompanying drawings.

In the drawings:

FIG. 1 is a schematic sectional view of a preferred embodiment of the steering system according to the invention, and

FIG. 2 is a schematic sectional view of the first stop element along line II-II in FIG. 1.

### DESCRIPTION OF THE INVENTION

The steering system according to the invention comprises a head tube 10 of a bicycle frame, which is typically connected to a top tube, not illustrated, and a down tube of the bicycle frame. An upper bearing element 12 and a lower bearing element 14 are arranged inside the head tube 10. The two bearing elements serve for rotatably supporting a steer tube 16 arranged inside the head tube 10. A handlebar stem, not illustrated, can be connected to the upper end of the steer tube 16 in the Figure. The lower end of the steer tube 16 in the Figure is typically connected to two fork legs via a fork bridge or is integrally formed.

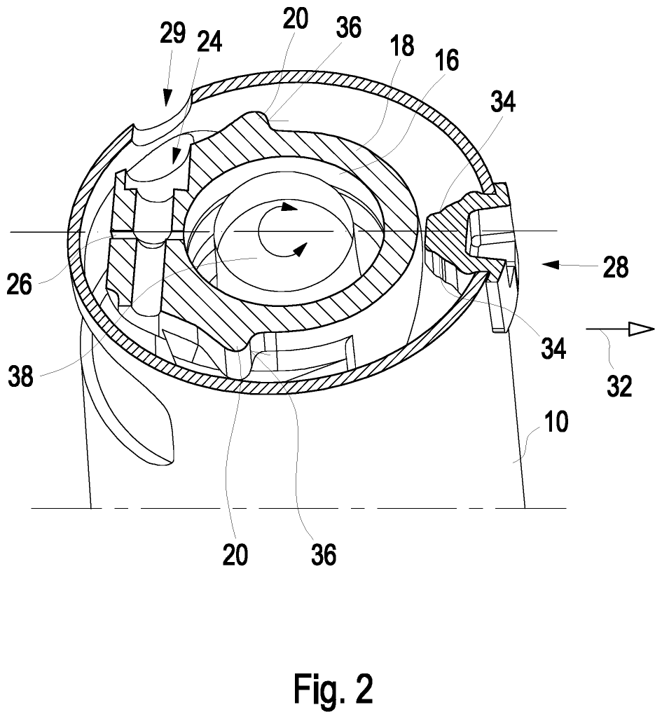

According to the invention, a first stop element 18 is arranged inside the head tube 10 between the two bearing elements 12, 14. In the embodiment illustrated, the first stop element 18 surrounds the steer tube 16 in an annular manner and has two opposing stop elements 20 (FIG. 2).

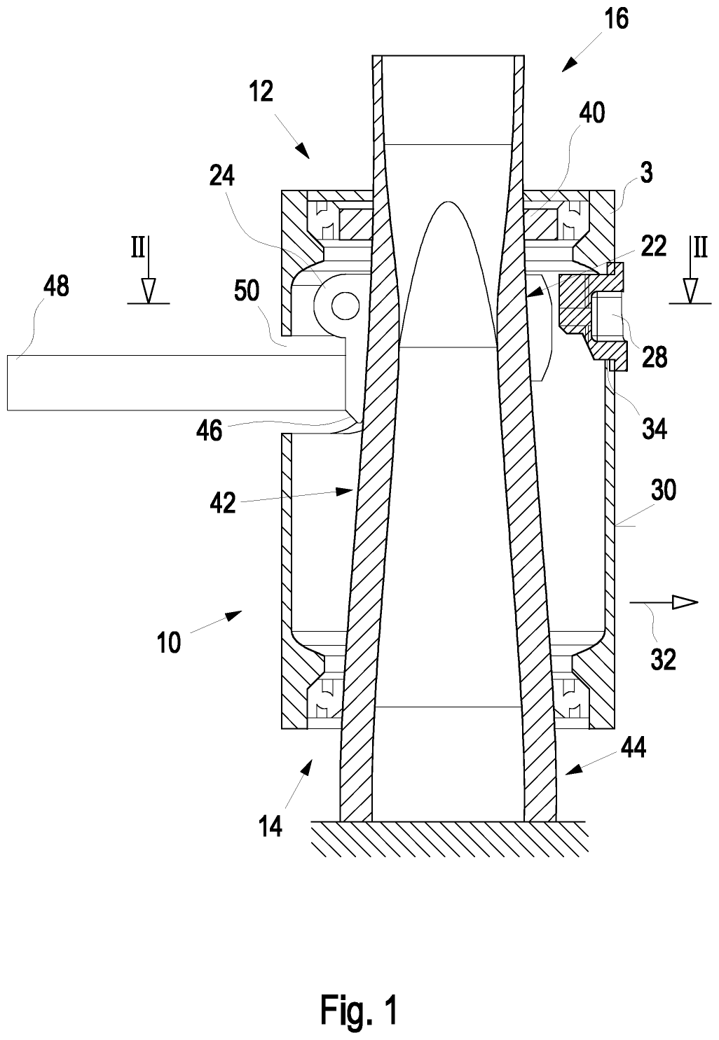

For a clamping fixation of the first stop element in a cylindrical portion 22 (FIG. 1) of the steer tube 16, the first stop element has a protrusion 24 in which a screw, not illustrated, can be arranged for a clamping fixation. The annular first stop element has a slit 26 in the region of the protrusion.

An opening 29 is provided in the head tube for access to the screw.

Further, a second stop element 28 is provided. The stop element 28 is arranged in a recess 34 on a front side 30 of the head tube 10, i.e. on a side of the head tube 10 facing in the traveling direction 32. In particular, a fixation can be realized in the recess by providing locking elements, clamping elements or the like. The stop element 28 has two opposing stop surfaces 34. These cooperate with the two stop surfaces 36 of the two stops 20 and thus define the maximum steering angle, as indicated by the arrow 38.

In the cylindrical portion 22 in the embodiment illustrated, the first stop element 18 is clampingly fixed and the upper bearing element 12 is arranged via an intermediate ring 40. Towards the lower bearing element 14, a conical portion 42 adjoins the cylindrical portion 22. The diameter of the conical portion 42 increases towards the lower bearing element 14, with the bearing element 14 preferably again being arranged in a cylindrical portion.

In a preferred embodiment, the first, in particular annular stop element 18 can be designed such that it also extends towards the lower bearing element 14 and thus comprises a further, in particular partially annular protrusion 46. The same preferably extends for at least 180° in the rear portion of the first stop element 28, i.e. the portion directed opposite to the traveling direction 32. A steering stabilization means can be connected to the protrusion 46. In the embodiment illustrated, a band-shaped element 48 is respectively arranged on both sides of the protrusion 46 approximately at the level of the stops 20. The same is guided through an opening 50 in the head tube 10 and extends into the top tube not illustrated herein Therein, the possibly elastic bands are fixed either directly or indirectly through a connection with another spring element. Using such a steering stabilization means, a restoring moment can be generated by the steering movement, which moment turns the handlebar back into the traveling direction. A combination of such a steering stabilization means in conjunction with a first stop element arranged between the two bearing elements 12, 14 is a particularly compact design of a steering stop in combination with a steering stabilization means.

Further aspects of the invention:
1. A steering system for bicycle handlebars comprising
   a steer tube (16) pivotably supported in a head tube (10) of a bicycle frame via two bearing elements (12, 14),
   a first stop element (18) with two stops (20), said element being adapted to be fixed on the steer tube (16) of a bicycle fork, and
   a second stop element (28) adapted to be fixed on the bicycle frame, in particular the head tube (10), and cooperating with the first stop element (18),
   characterized in that
   a first stop element (18) is arranged between the two bearing elements (12, 14).
2. The steering system according to aspect 1, characterized in that the first stop element (18) is fixed to the steer tube (16) in a force-locked manner, in particular in a clamping manner.
3. The steering system according to aspect 1 or 2, characterized in that the first stop element (18) is of annular design.
4. The steering system according to one of aspects 1 to 3, characterized in that the first stop element (18) comprises a clamping element for the clamping fixation on the steer tube.
5. The steering system according to one of aspects 1 to 4, characterized in that the steer tube (16) has a cylindrical portion (22) between the two bearing elements (12, 14), in which the first stop element (18) is arranged.
6. The steering system according to aspect 5, characterized in that the upper bearing element (12) is also arranged in the cylindrical portion (22).
7. The steering system according to one of aspects 5 to 6, characterized in that the cylindrical portion (22) is adjoined by a conical portion (42) that widens towards the lower bearing element (14).
8. The steering system according to one of aspects 1 to 7, characterized in that stop surfaces (36) of the first stop element (18) have an angle of at least 180°, preferably at least 220°, with respect to each other.
9. The steering system for bicycle handlebars according to any one of aspects 1 to 8, characterized in that the stops (20, 26) have stop surfaces (36) for limiting a left or right steering lock.
10. The steering system according to one of aspects 1 to 9, characterized in that the second stop element (28) is designed as an integral component of the head tube (10).
11. The steering system according to one of aspects 1 to 10, characterized in that the second stop element (28) is adapted to be arranged in a recess in the bicycle frame, in particular in the head tube (10) of the bicycle frame.
12. The steering system according to aspect 11, characterized in that the recess is arranged in a front side (30) of the head tube (10) facing to the traveling direction (32).

1. A steering system for bicycle handlebars comprising
a steer tube pivotably supported in a head tube of a bicycle frame via two bearing elements,
a first stop element with two stops, said element being adapted to be fixed on the steer tube of a bicycle fork, and
a second stop element adapted to be fixed on the bicycle frame, in particular the head tube, and cooperating with the first stop element,
wherein
a first stop element is arranged between the two bearing elements.

2. The steering system according to claim 1, wherein the first stop element is fixed to the steer tube in a force-locked manner, in particular in a clamping manner.

3. The steering system according to claim 1, wherein the first stop element is of annular design.

4. The steering system according to claim 1, wherein the first stop element comprises a clamping element for the clamping fixation on the steer tube.

5. The steering system according to claim 1, wherein the steer tube has a cylindrical portion between the two bearing elements, in which the first stop element is arranged.

6. The steering system according to claim 5, wherein the upper bearing element is also arranged in the cylindrical portion.

7. The steering system according to claim 5, wherein the cylindrical portion is adjoined by a conical portion that widens towards the lower bearing element.

8. The steering system according to claim 1, wherein stop surfaces of the first stop element have an angle of at least 180°, preferably at least 220°, with respect to each other.

9. The steering system for bicycle handlebars according to claim 1, wherein the stops have stop surfaces for limiting a left or right steering lock.

10. The steering system according to claim 1, wherein the second stop element is designed as an integral component of the head tube.

11. The steering system according to claim 1, wherein the second stop element is adapted to be arranged in a recess in the bicycle frame, in particular in the head tube of the bicycle frame.

12. The steering system according to claim 11, wherein the recess is arranged in a front side of the head tube facing to the traveling direction.

13. The steering system according to claim 1, wherein the first stop element is connected to a steering stabilization means, the steering stabilization means preferably comprising a spring element.

14. The steering system according to claim 12, wherein the steering stabilization means is at least partly arranged in the top tube of the bicycle frame.

15. The steering system according to claim 12, wherein the steering stabilization means comprises two in particular band-shaped stabilization elements which are connected to the first stop element preferably opposite each other.
